(19) United States
(12) Patent Application Publication
(10) Pub. No.: US 2026/0054492 A1
(43) Pub. Date: Feb. 26, 2026

(54) INKJET PRINTING APPARATUS

(71) Applicant: SCREEN Holdings Co., Ltd., Kyoto (JP)

(72) Inventors: Takanori TSUJI, Kyoto-shi (JP); Tamio FUKUI, Kyoto-shi (JP); Yuto SUZUKI, Kyoto-shi (JP); Takuya ITO, Kyoto-shi (JP)

(21) Appl. No.: 19/283,428

(22) Filed: Jul. 29, 2025

(30) Foreign Application Priority Data
Aug. 23, 2024 (JP) 2024-143399

(51) Int. Cl. B41J 2/185; B41J 2/175

(52) U.S. Cl. CPC B41J 2/185; B41J 2/17566; B41J 2/17596

(57) ABSTRACT

A collecting tank stores ink collected from a plurality of heads that discharge ink. A plurality of collecting-side individual pipes are connected respectively to the downstream sides of a plurality of the heads. A collecting-side manifold has a downstream end communicating with the collecting tank and is forked into a plurality of the collecting-side individual pipes. Further, a space portion is formed above the stored ink in the collecting tank. In addition, each of a plurality of the collecting-side individual pipes has a protruding portion protruding upward in an inverted U shape. An uppermost position of the protruding portion is located higher than an uppermost position of a plurality of the heads and the collecting-side manifold and lower than a liquid level of ink stored in the collecting tank. Moreover, an air pipe that allows communication between an internal passage of the protruding portion and the space portion is provided.

### RELATED APPLICATIONS

This application claims the benefit of Japanese application No. 2024-143399, filed on 23 Aug. 2024, the disclosure of which is incorporated by reference herein.

### BACKGROUND OF THE INVENTION

### Field of the Invention

The present disclosure relates to an inkjet printing apparatus that discharges ink onto a printing medium such as paper to perform printing.

### Description of the Background Art

Conventionally, an inkjet printing apparatus includes an ink circulation path through which ink is supplied to a discharge head configured to discharge ink onto a printing medium, and ink being left undischarged in the discharge head is collected and again supplied to the discharge head, in some cases. An inkjet printing apparatus including such an ink circulation path as mentioned above is described in, for example, Japanese Patent Application Laid-Open No. 2022-052563.

An inkjet printer (1) disclosed in JP 2022-052563 A includes a plurality of head parts (31) and a plurality of ink supply parts (4). The head part (31) has a discharge surface (33) facing a surface of a base material (9). The discharge surface (33) is provided with a plurality of nozzles. Then, an inkjet element discharges ink from the nozzle by a piezo method or a thermal method. The ink supply part (4) constitutes an ink circulation system that circulates ink while supplying ink to an ink chamber (35) communicating with the plurality of nozzles in the head part (31). The ink supply part (4) includes a supply tank (41), a return tank (43), a pressure difference forming part (5), and a first connection pipe (61). Ink stored in the supply tank (41) is movable to the ink chamber (35) of the head part (31) through the first connection pipe (61). Further, ink in the ink chamber (35) is movable to the return tank (43) through the first connection pipe (61). The pressure difference forming part (5) forms a pressure difference between the supply tank (41) and the return tank (43) by regulating a pressure in the supply tank (41) and a pressure in the return tank (43). Thus, ink is fed from the supply tank (41) toward the return tank (43).

When such an inkjet printer is not used for a long period of time or the like, a discharge port of the nozzle of the head part may dry, and a meniscus of ink near the discharge port may be disturbed. Then, when the meniscus of ink is disturbed, air may enter from outside to inside via the discharge port at the time of discharging the ink, and may be mixed into ink in the head part. In this case, if the inkjet printer is left as it is, air accumulation occurs in an ink circulation path. As a result, there is a possibility that a pressure difference between inside the supply tank and inside a collecting tank (return tank) is affected.

### SUMMARY OF THE INVENTION

An object of the present disclosure is to provide a technique capable of discharging air mixed in ink to outside.

In order to solve the above problem, a first aspect of the present application is an inkjet printing apparatus that performs printing by discharging ink onto a printing medium, and includes a plurality of heads, a supply tank, a collecting tank, a plurality of collecting-side individual pipes, and a collecting-side manifold. Each of a plurality of the heads discharges ink. The supply tank stores ink to be supplied to a plurality of the heads. The collecting tank stores ink collected from a plurality of the heads. A plurality of the collecting-side individual pipes are connected respectively to the downstream sides of a plurality of the heads. The collecting-side manifold has a downstream end communicating with the collecting tank and is forked into a plurality of the collecting-side individual pipes. Each of a plurality of the heads is located lower than the collecting-side manifold. Further, in the collecting tank, a space portion is formed above the stored ink. In addition, each of a plurality of the collecting-side individual pipes has a protruding portion protruding upward in an inverted U shape or an inverted V shape. Further, an uppermost position of the protruding portion is located higher than an uppermost position of the collecting-side manifold and lower than a liquid level of ink stored in the collecting tank. Moreover, an air pipe that allows communication between an internal passage of the protruding portion and the space portion is provided.

A second aspect of the present application is the inkjet printing apparatus according to the first aspect, further including a negative pressure application unit connected to the collecting tank and configured to apply a negative pressure to the inside of the collecting tank.

A third aspect of the present application is the inkjet printing apparatus according to the first aspect or the second aspect, further including a plurality of supply-side individual pipes, a supply-side manifold, and a feedback pipe. A plurality of the supply-side individual pipes are connected respectively to the upstream sides of a plurality of the heads. The supply-side manifold has an upstream end communicating with the supply tank and is forked into a plurality of the supply-side individual pipes. The feedback pipe allows passage of ink fed back from the collecting tank to the supply tank.

A fourth aspect of the present application is the inkjet printing apparatus according to the third aspect, further including a positive pressure application unit connected to the supply tank and configured to apply a positive pressure to the inside of the supply tank.

A fifth aspect of the present application is the inkjet printing apparatus according to the third aspect or the fourth aspect, further including a circulation pump, a control unit, and a liquid-level sensor. The circulation pump delivers ink from the collecting tank to the supply tank via the feedback pipe. The control unit can control the head and the circulation pump. The liquid-level sensor detects a liquid level of ink stored in the collecting tank. The control unit controls the circulation pump such that the liquid level of ink is located higher than an uppermost position of the protruding portion, on the basis of a detection result of the liquid level of ink obtained by the liquid-level sensor.

A sixth aspect of the present application is an inkjet printing apparatus that performs printing by discharging ink onto a printing medium, and the inkjet printing apparatus includes a plurality of heads, a supply tank, a plurality of supply-side individual pipes, a supply-side manifold, and a collecting tank. Each of a plurality of the heads discharges ink. The supply tank stores ink to be supplied to a plurality of the heads. A plurality of the supply-side individual pipes are connected respectively to the upstream sides of a plurality of the heads. The supply-side manifold has an upstream end communicating with the supply tank and is forked into a plurality of the supply-side individual pipes. The collecting tank stores ink collected from a plurality of the heads. Each of a plurality of the heads is located lower than the supply-side manifold. Further, in the supply tank, a space portion is formed above the stored ink. In addition, each of a plurality of the supply-side individual pipes has a protruding portion protruding upward in an inverted U shape or an inverted V shape. Further, an uppermost position of the protruding portion is located higher than an uppermost position of the supply-side manifold and lower than the liquid level of ink stored in the supply tank. Moreover, an air pipe that allows communication between an internal passage of the protruding portion and the space portion is provided.

According to the first to fifth aspects of the present application, air mixed in ink inside the head and in the collecting-side individual pipe can be discharged to the space portion of the collecting tank via the air pipe. As a result, it is possible to reduce generation of air accumulation inside the head and in the collecting-side individual pipe.

In particular, according to the second aspect of the present application, it is possible to reduce drop of ink from the head.

In particular, according to the fifth aspect of the present application, air mixed in ink in the collecting-side individual pipe can be more reliably discharged to the space portion of the collecting tank via the air pipe.

Furthermore, according to the sixth aspect of the present application, air mixed in ink inside the head and in the supply-side individual pipe can be discharged to the space portion of the supply tank via the air pipe. As a result, it is possible to reduce generation of air accumulation inside the head and in the supply-side individual pipe.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view conceptually showing a configuration of an inkjet printing apparatus;

FIG. 2 is a view conceptually showing configurations of an ink supply unit and a discharge head;

FIG. 3 is a block diagram showing connection between a control unit and each component of the inkjet printing apparatus; and

FIG. 4 is a view conceptually showing configurations of an ink supply unit and a discharge head according to a second preferred embodiment.

### DESCRIPTION OF THE PREFERRED EMBODIMENTS

Hereinafter, preferred embodiments of the present disclosure will be described with reference to the drawings. Note that components described in these preferred embodiments are mere examples and are not intended to limit the scope of the present disclosure to those only. In the drawings, for the purpose of easier understanding, the dimensions or the number of respective components are overstated or understated in some portions of illustration, as necessary.

### 1. First Preferred Embodiment

### <1-1. Configuration of Inkjet Printing Apparatus>

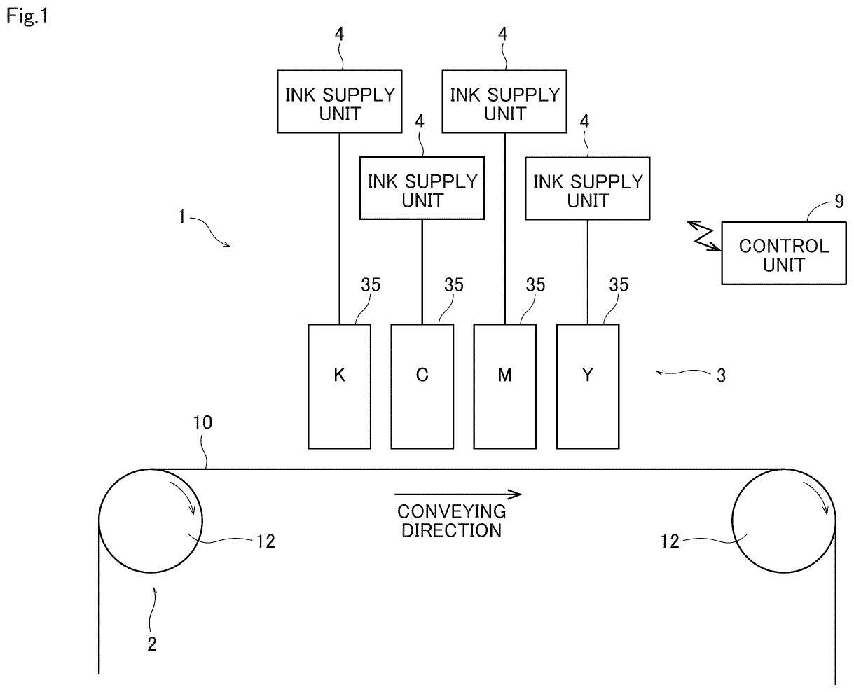

FIG. 1 is a view conceptually showing a configuration of an inkjet printing apparatus 1 according to one preferred embodiment of the present disclosure. The inkjet printing apparatus 1 is an inkjet printing machine that discharges droplets of water-based ink onto continuous paper 10, which have a shape of a long strip, from a plurality of discharge heads 35 while conveying the continuous paper 10, to record characters or images on a surface of the continuous paper 10. Note that the continuous paper 10, which have a shape of a long strip, is just one example of a printing medium. The printing medium may be a cut sheet, a plastic film, cardboard, metal foil, a glass material, or the like. In other words, the inkjet printing apparatus 1 may be any apparatus that can discharge ink onto a printing medium to perform printing. As shown in FIG. 1, the inkjet printing apparatus 1 includes a conveyor unit 2, a printing unit 3, and a control unit 9.

The conveyor unit 2 is a mechanism configured to convey the continuous paper 10 along a predetermined conveying path in a conveying direction extending along a length direction of the continuous paper 10. The continuous paper 10 is stretched over a plurality of conveyor rollers 12. The continuous paper 10 is conveyed along a conveying path formed by the plurality of conveyor rollers 12. Each of the conveyor rollers 12 rotates about an axis extending in a direction perpendicular to the conveying direction, to thereby guide the continuous paper 10 to the downstream side in the conveying path. Further, the continuous paper 10 is under tension in the conveying direction. This reduces slack or wrinkles in the continuous paper 10 during conveying.

The printing unit 3 includes a plurality of discharge heads 35 and a plurality of ink supply units 4. In the present embodiment, the printing unit 3 includes four discharge heads 35 and four ink supply units 4. The four discharge heads 35 have substantially the same configuration with each other. Further, the four ink supply units 4 have substantially the same configuration with each other.

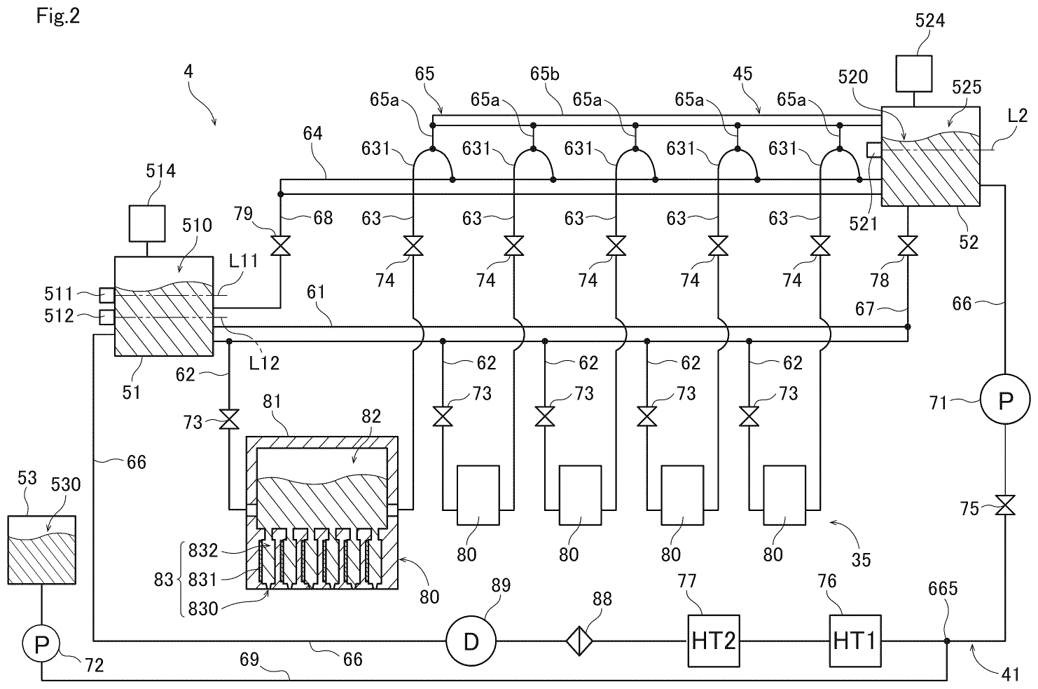

The four discharge heads 35 are arranged while being spaced from each other along the conveying direction. Each of the four discharge heads 35 discharges ink droplets onto a surface (upper surface) of the continuous paper 10 from nozzles 83 (refer to FIG. 2 described later). In the present embodiment, the four discharge heads 35 discharge ink of different colors, respectively, to thereby each record a monochromatic image on the surface (upper surface) of the continuous paper 10. For example, the four discharge heads 35 discharge cyan ink, magenta ink, yellow ink, and black ink, respectively. Then, the four monochromatic images are superimposed, so that a multicolor image is formed on the upper surface of the continuous paper 10.

FIG. 2 is a view conceptually showing a configuration of one ink supply unit 4 and a configuration of one discharge head 35. In the present embodiment, each of the discharge heads 35 includes a plurality of heads 80 each of which discharges ink. In the present embodiment, each of the discharge heads 35 includes five heads 80. The five heads 80 have substantially the same configuration with each other. Hence, in FIG. 2, only one of the five heads 80 is shown in detail, and the other four heads 80 are shown in a simplified manner. As shown in FIG. 2, each of the five heads 80 includes a casing 81, an internal tank 82, and a plurality of nozzles 83.

The casing 81 forms an outer frame of the head 80. The internal tank 82 is provided in the casing 81, and ink can be temporarily stored therein. The plurality of nozzles 83 are arranged while being equally spaced from each other along the conveying direction and a width direction of the continuous paper 10 in a lower portion of the casing 81. Each of the plurality of nozzles 83 communicates with the internal tank 82. Further, each of the plurality of nozzles 83 includes a plurality of piezoelectric elements 831 serving as pressure generation elements, an ink chamber 832, and a discharge port 830. The ink chamber 832 communicates with the internal tank 82.

During discharge of ink, ink flows down from the internal tank 82 to the ink chamber 832. Then, under the control of the piezoelectric elements 831, ink in the ink chamber 832 is pressurized, and thus is discharged in the form of liquid droplets from the discharge port 830. Alternatively, the nozzle 83 may be a so-called thermal nozzle in which ink in the ink chamber 832 is heated to generate bubbles and thus is pressurized.

Next, the ink supply unit 4 is described. The ink supply unit 4 is a device configured to supply ink to the discharge heads 35 while circulating a part of ink. As described above, the inkjet printing apparatus 1 of the present embodiment includes four ink supply units 4. The four ink supply units 4 have substantially the same configuration with each other, and hence only a configuration of one ink supply unit 4 is described below.

As shown in FIG. 2, each of the ink supply units 4 includes a supply tank 51, a collecting tank 52, a replenishment tank 53, a supply-side manifold 61, a plurality of supply-side individual pipes 62, a plurality of collecting-side individual pipes 63, a collecting-side manifold 64, an air pipe 65, a feedback pipe 66, a first bypass pipe 67, a second bypass pipe 68, a branch pipe 69, a circulation pump 71, a replenishment pump 72, a plurality of supply-side on-off valves 73, a plurality of head outlet-side on-off valves 74, a feedback-side on-off valve 75, a first heater 76, a second heater 77, a first bypass on-off valve 78, a second bypass on-off valve 79, a filter 88, and a deaeration unit 89. In the present embodiment, each of the ink supply units 4 includes five supply-side individual pipes 62, five collecting-side individual pipes 63, five supply-side on-off valves 73, and five head outlet-side on-off valves 74.

The supply tank 51 is a container for temporally storing ink to be supplied to the discharge heads 35. That is, the supply tank 51 stores ink to be supplied to the plurality of heads 80. In the supply tank 51, an internal chamber 510 in which ink can be temporally stored is provided. Further, in the supply tank 51, a first upper liquid-level sensor 511, a first lower liquid-level sensor 512, and a “first Full sensor” and a “first Empty sensor” which are not shown are mounted.

Each of the first upper liquid-level sensor 511 and the first lower liquid-level sensor 512 is electrically connected to the control unit 9. When the first upper liquid-level sensor 511 detects that a liquid level of ink stored in the internal chamber 510 of the supply tank 51 is a first upper reference value L11, the first upper liquid-level sensor 511 outputs a first upper signal to the control unit 9 via a communication circuit (not shown). When the first lower liquid-level sensor 512 detects that the liquid level of ink stored in the internal chamber 510 of the supply tank 51 is a first lower reference value L12, the first lower liquid-level sensor 512 outputs a first lower signal to the control unit 9 via a communication circuit (not shown). Note that the first lower reference value L12 is a value lower than the first upper reference value L11.

Further, when the “first Full sensor” detects that ink stored in the internal chamber 510 is full, the “first Full sensor” outputs a “first Full signal” to the control unit 9 via a communication circuit (not shown). Further, when the “first Empty sensor” detects that ink stored in the internal chamber 510 is empty, the “first Empty sensor” outputs a “first Empty signal”to the control unit 9 via a communication circuit (not shown).

The supply-side manifold 61 and the five supply-side individual pipes 62 are pipes connecting the supply tank 51 and the five heads 80 included in one discharge head 35. The supply-side manifold 61 is a wide pipe having an upstream end that is connected so as to communicate with the internal chamber 510 of the supply tank 51. Further, the supply-side manifold 61 of the present embodiment is connected to a side surface of a lower portion of the supply tank 51, and extends in a substantially horizontal direction. Each of the five supply-side individual pipes 62 is a narrow pipe branching from the supply-side manifold 61. That is, the supply-side manifold 61 has an upstream end communicating with the supply tank 51 and is forked into the five supply-side individual pipes 62.

Each of the five supply-side individual pipes 62 has an upstream end communicating with an internal passage of the supply-side manifold 61, and has a downstream end that is connected so as to communicate with the internal tank 82 of one head 80. Thus, the five supply-side individual pipes 62 are connected to the five heads 80, respectively. Further, the five supply-side individual pipes 62 are respectively connected to the upstream sides of the five heads 80 in an ink circulation path 41 to be described later.

Further, in the present embodiment, the supply-side on-off valve 73 is interposed in each of the supply-side individual pipes 62. For the supply-side on-off valve 73, for example, a solenoid valve that is opened and closed under the control of the control unit 9 is used. Alternatively, for the supply-side on-off valve 73, an on-off valve that is manually opened and closed may be used. While the supply-side on-off valve 73 is closed, an internal passage of the supply-side individual pipe 62 is blocked from communicating. That is, while the supply-side on-off valve 73 is closed, ink flow from the supply tank 51 to the head 80 is interrupted. Meanwhile, while the supply-side on-off valve 73 is opened, the internal passage of the supply-side individual pipe 62 is allowed to communicate. Note that the supply-side on-off valve 73 is not necessarily required to be provided. Further, a filter or the like may be further interposed in the supply-side manifold 61 or each of the five supply-side individual pipes 62.

The five collecting-side individual pipes 63 and the collecting-side manifold 64 are pipes connecting the five heads 80 included in one discharge head 35 and the collecting tank 52. Each of the five collecting-side individual pipes 63 is a narrow pipe branching from the collecting-side manifold 64. Each of the five collecting-side individual pipes 63 has an upstream end that is connected so as to communicate with the internal tank 82 of one head 80, and has a downstream end that is connected so as to communicate with an internal passage of the collecting-side manifold 64. Thus, the five collecting-side individual pipes 63 are connected to the five heads 80, respectively. Further, the five collecting-side individual pipes 63 are respectively connected to the downstream sides of the five heads 80 in the ink circulation path 41 to be described later.

Further, in the present embodiment, a part of each of the collecting-side individual pipes 63 has a curved shape protruding upward in an inverted U shape. Hereinafter, a portion of each of the collecting-side individual pipes 63 protruding upward is referred to as a “protruding portion 631”. The protruding portion 631 is located higher than a portion other than the protruding portion 631 in each of the collecting-side individual pipes 63. Further, an uppermost position of the protruding portion 631 is located higher than an uppermost position of the collecting-side manifold 64. However, the protruding portion 631 may protrude upward in an inverted V shape. Further, the protruding portion 631 may be formed at an end portion of each of the collecting-side individual pipes 63. That is, it suffices that each of the five collecting-side individual pipes 63 has the protruding portion 631 protruding upward in an inverted U shape or an inverted V shape.

The collecting-side manifold 64 is a wide pipe having a downstream end that is connected so as to communicate with an internal chamber 520 of the collecting tank 52 described later. Further, the collecting-side manifold 64 of the present embodiment is connected to a side surface of a lower portion of the collecting tank 52, and extends in a substantially horizontal direction. That is, the collecting-side manifold 64 has a downstream end communicating with the collecting tank 52 and is forked into the five collecting-side individual pipes 63. In addition, each of the five heads 80 of the present embodiment is located lower than the collecting-side manifold 64. Note that, in FIG. 2, the collecting-side manifold 64 is shown to be located higher than the supply-side manifold 61. However, the supply-side manifold 61 and the collecting-side manifold 64 are desirably located at substantially the same height as each other. This makes it possible to reduce a space occupied by the supply-side manifold 61 and the collecting-side manifold 64 in a vertical direction. Further, as in the present embodiment, both the supply-side manifold 61 and the collecting-side manifold 64 desirably extend in a substantially horizontal direction. This makes it possible to stabilize delivery of ink in the supply-side manifold 61 and the collecting-side manifold 64.

Further, in the present embodiment, the head outlet-side on-off valve 74 is interposed in each of the collecting-side individual pipes 63. For the head outlet-side on-off valve 74, for example, a solenoid valve that is opened and closed under the control of the control unit 9 is used. Alternatively, for the head outlet-side on-off valve 74, an on-off valve that is manually opened and closed may be used. While the head outlet-side on-off valve 74 is closed, an internal passage of the collecting-side individual pipe 63 is blocked from communicating. That is, while the head outlet-side on-off valve 74 is closed, ink flow from the head 80 to the collecting tank 52 is interrupted. Meanwhile, while the head outlet-side on-off valve 74 is opened, the internal passage of the collecting-side individual pipe 63 is allowed to communicate. Note that the head outlet-side on-off valve 74 is not necessarily required to be provided. Further, a filter or the like may be further interposed in each of the five collecting-side individual pipes 63 or the collecting-side manifold 64.

The collecting tank 52 is a container for temporally storing ink collected from the five heads 80. In the collecting tank 52, the internal chamber 520 in which ink can be temporally stored is provided. Further, in the collecting tank 52, a second liquid-level sensor 521, and a “second Full sensor”and a “second Empty sensor”which are not shown are mounted.

The second liquid-level sensor 521 is an example of a “liquid-level sensor” of the present disclosure. The second liquid-level sensor 521 is electrically connected to the control unit 9. When the second liquid-level sensor 521 detects that the liquid level of ink stored in the internal chamber 520 of the collecting tank 52 is a second reference value L2, the second liquid-level sensor 521 outputs a second signal to the control unit 9 via a communication circuit (not shown). That is, the inkjet printing apparatus 1 includes the “liquid-level sensor” for detecting the liquid level of ink stored in the collecting tank 52. Note that the second reference value L2 is located higher than the uppermost position of the protruding portion 631.

Further, when the “second Full sensor” detects that ink stored in the internal chamber 520 is full, the “second Full sensor” outputs a “second Full signal” to the control unit 9 via a communication circuit (not shown). Further, when the “second Empty sensor” detects that ink stored in the internal chamber 520 is empty, the “second Empty sensor” outputs a “second Empty signal”to the control unit 9 via a communication circuit (not shown).

Further, as shown in FIG. 2, the supply tank 51 is connected to a pressurization mechanism 514. The pressurization mechanism 514 pressurizes the inside of the supply tank 51, to regulate a pressure of the internal chamber 510 of the supply tank 51 to a positive pressure. That is, the pressurization mechanism 514 regulates the pressure in the internal chamber 510 of the supply tank 51 to be higher than an atmospheric pressure. The pressurization mechanism 514 includes, for example, a compressor, a pressurization buffer tank, a pressure regulation mechanism (regulator), and the like. Note that the pressurization mechanism 514 is an example of a “positive pressure application unit” of the present disclosure. That is, the inkjet printing apparatus 1 further includes the positive pressure application unit connected to the supply tank 51 and configured to apply a positive pressure to the inside of the supply tank 51.

Meanwhile, the collecting tank 52 is connected to a decompression mechanism 524. The decompression mechanism 524 decompresses the inside of the collecting tank 52, to regulate a pressure of the internal chamber 520 of the collecting tank 52 to a negative pressure. That is, the decompression mechanism 524 regulates the pressure of the internal chamber 520 of the collecting tank 52 to be lower than an atmospheric pressure. The decompression mechanism 524 includes, for example, a vacuum pump, a decompression buffer tank, a pressure regulation mechanism (regulator), and the like. Note that, the decompression mechanism 524 is an example of a “negative pressure application unit” of the present disclosure. That is, the inkjet printing apparatus 1 further includes the negative pressure application unit connected to the collecting tank 52 and configured to apply a negative pressure to the inside of the collecting tank 52.

Note that, the pressurization mechanism 514 and the decompression mechanism 524 are configured such that the operations thereof can be controlled by the control unit 9. When the pressurization mechanism 514 and the decompression mechanism 524 are driven, there is generated a pressure difference between the internal chamber 510 of the supply tank 51 and the internal chamber 520 of the collecting tank 52. As a result, ink stored in the supply tank 51 can be supplied to each of the five heads 80 of the discharge head 35, and further, ink remaining in the each of the five heads 80 can be collected into the collecting tank 52. Note that the ink remaining in each of the five heads 80 is ink being left undischarged in each of the five heads 80. Furthermore, an amount of ink supplied from the supply tank 51 to the five heads 80 and an amount of ink collected from the five heads 80 to the collecting tank 52 can be individually adjusted by controlling driving of the pressurization mechanism 514 and the decompression mechanism 524. Furthermore, by driving the decompression mechanism 524 to set the pressure of the internal chamber 520 of the collecting tank 52 to a negative pressure, it is possible to reduce drop of ink from the vicinity of the nozzle 83 of each of the heads 80.

Note that the pressurization mechanism 514 and the decompression mechanism 524 are not necessarily required to make a pressure of the internal chamber 510 of the supply tank 51 and a pressure of the internal chamber 520 of the collecting tank 52, positive and negative, respectively, as long as those pressures can be regulated such that the pressure of the internal chamber 510 of the supply tank 51 is higher than the pressure of the internal chamber 520 of the collecting tank 52. For example, the pressurization mechanism 514 may regulate the pressure of the internal chamber 510 of the supply tank 51 to a pressure of a degree equal to the atmospheric pressure, and the decompression mechanism 524 may regulate the pressure of the internal chamber 520 of the collecting tank 52 to a negative pressure (pressure lower than the atmospheric pressure).

As will be described in detail later, the control unit 9 controls the circulation pump 71 such that the liquid level of ink stored in the collecting tank 52 is located slightly higher than the second reference value L2 on the basis of a detection result of the liquid level of ink obtained by the second liquid-level sensor 521. Therefore, air is present above ink stored in the internal chamber 520 of the collecting tank 52. That is, in the collecting tank 52, a “space portion 525” is formed above the stored ink.

Further, as described above, the second reference value L2 is located higher than the uppermost position of the protruding portion 631. That is, on the basis of a detection result of the liquid level of ink obtained by the second liquid-level sensor 521, the control unit 9 controls the circulation pump 71 such that the liquid level of ink stored in the collecting tank 52 is located higher than the uppermost position of the protruding portion 631. In other words, the uppermost position of the protruding portion 631 is located lower than the liquid level of ink stored in the collecting tank 52. Note that, an effect obtained by setting a positional relationship between the liquid level of ink in the collecting tank 52 and the protruding portion 631 in this manner will be described in detail later.

The air pipe 65 includes a plurality of individual air pipes 65a and a common air pipe 65b. In the present embodiment, the air pipe 65 includes five individual air pipes 65a. Each of the five individual air pipes 65a is connected to one collecting-side individual pipe 63 and extends upward. Further, each of the five individual air pipes 65a is connected to a portion of each corresponding collecting-side individual pipe 63 near the uppermost position of the protruding portion 631. The common air pipe 65b has a downstream end communicating with the collecting tank 52 and is forked into five individual air pipes 65a. Further, the common air pipe 65b is connected to an upper side surface of the collecting tank 52. Thus, an internal passage of the air pipe 65 allows communication between an internal passage of each of the collecting-side individual pipes 63 near the uppermost position of the protruding portion 631 and the space portion 525 formed in an upper portion of the internal chamber 520 of the collecting tank 52, via the five individual air pipes 65a and the common air pipe 65b. Accordingly, the internal passage of each of the collecting-side individual pipes 63 communicates with the space portion 525 of the collecting tank 52 via the air pipe 65. As a result, an air discharge path 45 is formed from each of the collecting-side individual pipes 63 toward the space portion 525 of the collecting tank 52 via the air pipe 65. Note that, an inclination of the common air pipe 65b is not particularly limited as long as the entire common air pipe 65b is located higher than the second reference value L2. For example, the inclination of the common air pipe 65b may be horizontal. However, the common air pipe 65b desirably has an inclination in which an upstream end opposite to the downstream end connected to the collecting tank 52 is located slightly higher than the downstream end. Thus, as will be described in detail later, even if ink leaks when air moves from the collecting-side individual pipe 63 to the space portion 525 of the collecting tank 52 via the air pipe 65, ink can be more easily directed into the collecting tank 52 by the gravity applied to the ink.

The feedback pipe 66 is a pipe connecting the internal chamber 520 of the collecting tank 52 and the internal chamber 510 of the supply tank 51 in such a manner as to allow the internal chambers to communicate with each other. As shown in FIG. 2, an internal passage of the feedback pipe 66 has an upstream end that is connected so as to communicate with the internal chamber 520 of the collecting tank 52. Further, the internal passage of the feedback pipe 66 has a downstream end that is connected so as to communicate with the internal chamber 510 of the supply tank 51. The feedback pipe 66 allows passage of ink fed back from the collecting tank 52 into the supply tank 51.

With the above-described configuration, there is formed the ink circulation path 41 that starts from the supply tank 51, extends through the supply-side manifold 61, the supply-side individual pipes 62, the internal tanks 82 of the heads 80, the collecting-side individual pipes 63, the collecting-side manifold 64, the collecting tank 52, and the feedback pipe 66, and returns back to the supply tank 51. In addition, the circulation pump 71, the feedback-side on-off valve 75, the first heater 76, the second heater 77, the filter 88, and the deaeration unit 89 are interposed in the feedback pipe 66.

The first bypass pipe 67 is a bypass pipe between a portion of the supply-side manifold 61 near a downstream end of the ink circulation path 41 and a lower portion of the collecting tank 52. The second bypass pipe 68 is a bypass pipe between a portion of the collecting-side manifold 64 near an upstream end of the ink circulation path 41 and a lower portion of the supply tank 51. Thus, in the present embodiment, when ink flows from the supply tank 51 to the collecting tank 52, in addition to the flow path that passes through the head 80, the flow path that does not pass through the head 80 but passes through the first bypass pipe 67 or the second bypass pipe 68 to flow toward the collecting tank 52 is provided in parallel.

Further, the first bypass on-off valve 78 is interposed in the first bypass pipe 67. Further, the second bypass on-off valve 79 is interposed in the second bypass pipe 68. For the first bypass on-off valve 78 and the second bypass on-off valve 79, for example, a solenoid valve that opens and closes under the control of the control unit 9 is used. However, an on-off valve that is manually opened and closed may be used for the first bypass on-off valve 78 and the second bypass on-off valve 79. While the first bypass on-off valve 78 is closed, an internal passage of the first bypass pipe 67 is blocked from communicating, and ink flow from the supply-side manifold 61 toward the collecting tank 52 via the first bypass pipe 67 is interrupted. Whereas, while the first bypass on-off valve 78 is opened, the internal passage of the first bypass pipe 67 is allowed to communicate. Further, while the second bypass on-off valve 79 is closed, an internal passage of the second bypass pipe 68 is blocked from communicating, and ink flow from the supply tank 51 toward the collecting-side manifold 64 via the second bypass pipe 68 is interrupted. Whereas, while the second bypass on-off valve 79 is opened, the internal passage of the second bypass pipe 68 is allowed to communicate.

At a time of starting the inkjet printing apparatus 1, for example, the five supply-side on-off valves 73 and the five head outlet-side on-off valves 74 are closed while the first bypass on-off valve 78 and the second bypass on-off valve 79 are opened. Then, by driving the circulation pump 71, ink can be quickly circulated in a large capacity via the first bypass pipe 67 and the second bypass pipe 68 without causing ink to pass through a narrow passage near the five heads 80 in the ink circulation path 41. Thus, a temperature of ink circulating in the ink circulation path 41 can be raised to a target temperature in a shorter time by driving the first heater 76 and/or the second heater 77.

The circulation pump 71 is a device configured to perform a pumping operation of delivering ink from the collecting tank 52 to the supply tank 51 via the feedback pipe 66. The circulation pump 71 generates ink flow from the collecting tank 52 to the supply tank 51 in the internal passage of the feedback pipe 66 in response to an operation signal from the control unit 9. For the circulation pump 71 of the present embodiment, for example, a pump in which foreign matters such as dust are unlikely to be generated during driving, such as a diaphragm pump, is used.

The feedback-side on-off valve 75 is interposed in the feedback pipe 66, on the downstream side of the circulation pump 71 and on the upstream side of the supply tank 51. The feedback-side on-off valve 75 is used, for example, to temporarily stop ink flow in the ink circulation path 41 at a time of cleaning the filter 88 or the like. For the feedback-side on-off valve 75, for example, an electric valve that is opened and closed under the control of the control unit 9 is used. Alternatively, for the feedback-side on-off valve 75, an on-off valve that is manually opened and closed may be used. While the feedback-side on-off valve 75 is closed, the internal passage of the feedback pipe 66 is blocked from communicating. That is, while the feedback-side on-off valve 75 is closed, ink flow from the collecting tank 52 to the supply tank 51 is stopped. Whereas, while the feedback-side on-off valve 75 is opened, communication of the internal passage of the feedback pipe 66 is secured.

The first and second heaters 76 and 77 are devices configured to heat ink delivered through the internal passage of the feedback pipe 66. The first and second heaters 76 and 77 heat ink flowing from the collecting tank 52 to the supply tank 51. The first and second heaters 76 and 77 are located between the circulation pump 71 and the supply tank 51 in the feedback pipe 66. Further, the second heater 77 is located on the downstream side of the first heater 76 in an ink delivery direction in the ink circulation path 41.

The first and second heaters 76 and 77 each include a heating element formed of a carbon heater or the like, and is connected to a power supply via an ON/OFF circuit not shown. Then, the first and second heaters 76 and 77 each can heat ink by generating heat in an ON state in which power is turned on. More specifically, the first heater 76 is controlled such that, for example, a temperature of ink flowing out of the first heater 76 is equal to a first target temperature higher than a room temperature, by switching between an ON state and an OFF state. Further, the second heater 77 is controlled such that, for example, a temperature of ink flowing out of the second heater 77 is equal to a second target temperature higher than the first target temperature, by switching between an ON state and an OFF state. Note that, the second target temperature is substantially equal to a temperature suitable for discharging ink from each of the heads 80. Note that, the number of heaters interposed between the circulation pump 71 and the supply tank 51 in the feedback pipe 66 may be one or three or larger.

The filter 88 is interposed on the downstream side of the second heater 77 with respect to the ink delivery direction and on the upstream side of the supply tank 51 with respect to the ink delivery direction in the feedback pipe 66. The filter 88 filters ink delivered through the internal passage of the feedback pipe 66, to remove foreign matters included in the ink.

The deaeration unit 89 is interposed on the downstream side of the filter 88 with respect to the ink delivery direction and on the upstream side of the supply tank 51 with respect to the ink delivery direction in the feedback pipe 66. The deaeration unit 89 of the present embodiment is a so-called hollow-fiber membrane deaeration module. The deaeration unit 89 removes bubbles in ink delivered through the internal passage of the feedback pipe 66. Note that the bubbles in ink are, for example, fine bubbles generated from the circulation pump 71.

The replenishment tank 53 is a container for storing ink outside the ink circulation path 41. The replenishment tank 53 stores ink to be replenished to the ink circulation path 41. In the replenishment tank 53, an internal chamber 530 in which ink can be stored is provided. A sufficient amount of ink is always stored in the internal chamber 530 of the replenishment tank 53.

The branch pipe 69 is a pipe connecting the internal chamber 530 of the replenishment tank 53 and the internal passage of the feedback pipe 66 in such a manner as to allow communication with each other. The branch pipe 69 connects the replenishment tank 53 with a branch position 665 between the feedback-side on-off valve 75 and the first heater 76 in the feedback pipe 66. An internal passage of the branch pipe 69 is connected so as to communicate with the internal chamber 530 of the replenishment tank 53 at an upstream end. Further, the internal passage of the branch pipe 69 is connected so as to communicate with the internal passage of the feedback pipe 66 at the branch position 665 located at a downstream end of the branch pipe 69. Further, in the branch pipe 69, the replenishment pump 72 is interposed.

The replenishment pump 72 is a device configured to perform a pumping operation of delivering ink from the replenishment tank 53 to the feedback pipe 66. The replenishment pump 72 delivers ink from the replenishment tank 53 to the ink circulation path 41 via the branch pipe 69. For the replenishment pump 72 of the present embodiment, for example, a pump (for example, a diaphragm pump) having the same type of structure as the circulation pump 71 is used.

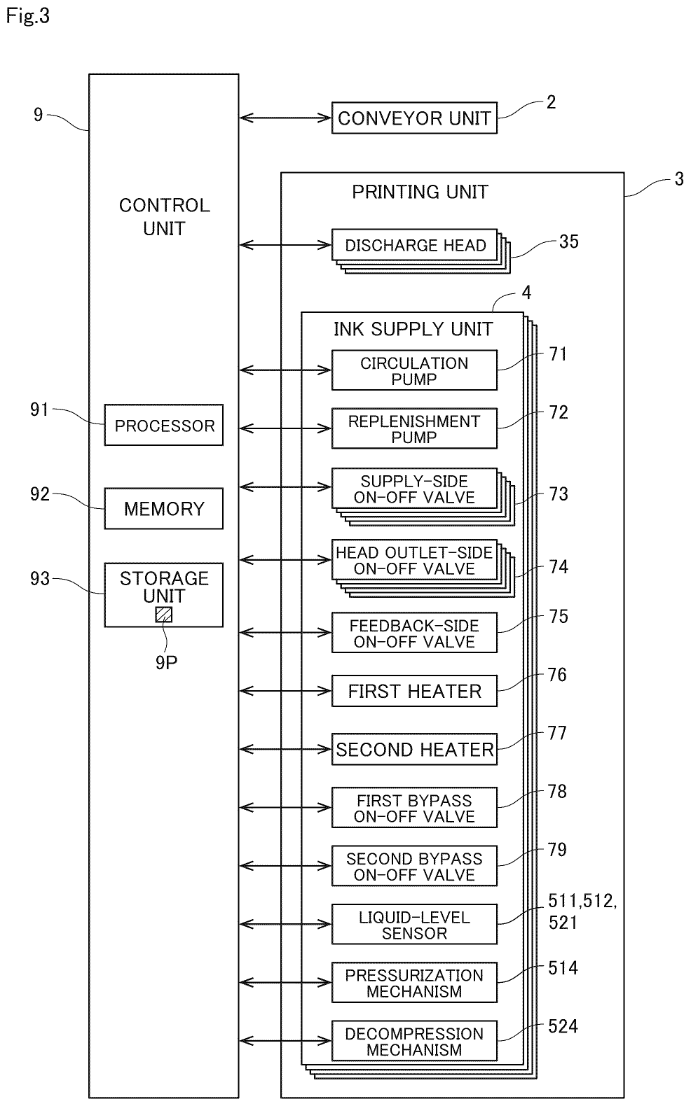

Next, the control unit 9 is described. The control unit 9 is an information processing device configured to control each component of the inkjet printing apparatus 1. FIG. 3 is a block diagram showing connection between the control unit 9 and each component of the inkjet printing apparatus 1. As conceptually shown in FIG. 3, the control unit 9 includes a processor 91 such as a CPU, a memory 92 such as a RAM, and a storage unit 93 such as a hard disk drive. The storage unit 93 stores a computer program 9P for executing a printing process while conveying the continuous paper 10, and circulating a part of ink while supplying ink to the discharge head 35.

Further, as shown in FIG. 3, the control unit 9 is electrically connected to the conveyor unit 2 and each of the heads 80 of the four discharge heads 35 of the printing unit 3, and is further electrically connected to the circulation pump 71, the replenishment pump 72, the five supply-side on-off valves 73, the five head outlet-side on-off valves 74, the feedback-side on-off valve 75, the first heater 76, the second heater 77, the first bypass on-off valve 78, the second bypass on-off valve 79, each of the liquid-level sensors 511, 512, and 521, the pressurization mechanism 514, and the decompression mechanism 524 of each of the four ink supply units 4 of the printing unit 3, such that the control unit 9 can conduct communication to/from the above-described components.

That is, the control unit 9 can individually control the conveyor unit 2 and each of the heads 80 of the four discharge heads 35 of the printing unit 3, and can individually control the circulation pump 71, the replenishment pump 72, the five supply-side on-off valves 73, the five head outlet-side on-off valves 74, the feedback-side on-off valve 75, the first heater 76, the second heater 77, the first bypass on-off valve 78, the second bypass on-off valve 79, each of the liquid-level sensors 511, 512, and 521, the pressurization mechanism 514, and the decompression mechanism 524 of each of the four ink supply units 4 of the printing unit 3. The control unit 9 controls operations of those components in accordance with the computer program 9P. As a result, conveyance and the printing process of the continuous paper 10 proceed, ink is supplied to the internal tank 82 of each discharge head 35, and a part of ink further circulates.

### <1-2. Outline of Conveyance and Printing Processes of Continuous Paper, and Procedure of Ink Supply and Circulation>

Next, a description will be given to an outline of conveyance and the printing process of the continuous paper 10 carried out in the inkjet printing apparatus 1, and to a procedure of supplying ink to the internal tank 82 of each discharge head 35 and circulating a part of ink.

Note that, as a preparation before carrying out conveyance of the continuous paper 10 and the printing process, ink is stored in the internal chamber 510 of the supply tank 51 until the liquid level of ink becomes equal to or larger than the first upper reference value L11 (at least equal to or larger than the first lower reference value L12). Further, ink is stored in the internal chamber 520 of the collecting tank 52 until the liquid level of ink becomes equal to or larger than the second reference value L2. Further, a sufficient amount of ink is stored in the internal chamber 530 of the replenishment tank 53. Further, the control unit 9 opens the five supply-side on-off valves 73, the five head outlet-side on-off valves 74, and the feedback-side on-off valve 75. Whereas, the control unit 9 individually closes the first bypass on-off valve 78 and the second bypass on-off valve 79, except a case of increasing a temperature of ink in a short time, such as at a time of starting the inkjet printing apparatus 1.

Then, at the time of carrying out the conveyance and the printing process of the continuous paper 10, the control unit 9 operates the conveyor unit 2 to control the plurality of nozzles 83 of each of the four discharge heads 35 while conveying the continuous paper 10 in a length direction along a predetermined conveying path. As a result, the control unit 9 discharges ink droplets onto a surface of the continuous paper 10 to record an image on the surface of the continuous paper 10.

Further, the control unit 9 drives the circulation pump 71, the first heater 76, the second heater 77, the pressurization mechanism 514, and the decompression mechanism 524 of each of the four ink supply units 4. In addition, power of each of the liquid-level sensors 511, 512, and 521 is turned on, and each of these sensors starts measurement. Thus, the control unit 9 can supply ink stored in the supply tank 51 to each of the five heads 80 of the discharge head 35 while circulating ink in the ink circulation path 41. Moreover, the control unit 9 can collect ink remaining in each of the five heads 80 to the collecting tank 52, and return ink to the supply tank 51 again. That is, the control unit 9 can collect, in the collecting tank 52, ink that has not been discharged from each of the five heads 80 but has been retained and lowered in temperature. Furthermore, the control unit 9 can individually adjust an amount of ink supplied from the supply tank 51 to the five heads 80 and an amount of ink collected from the five heads 80 to the collecting tank 52, by controlling driving of the pressurization mechanism 514 and the decompression mechanism 524.

Here, when the inkjet printing apparatus 1 is not used for a long period of time, or the like, the discharge port 830 of the nozzle 83 may dry, and a meniscus of the ink near the discharge port 830 may be disturbed. Then, when the meniscus of ink is disturbed, air may enter from outside to inside via the discharge port 830 at the time of discharging the ink, and may be mixed in ink stored in the ink chamber 832 or the internal tank 82. In this case, if the inkjet printing apparatus 1 is left as it is, air accumulation may occur in the ink circulation path 41. Then, accordingly, there may be an impact on pressure regulation by the pressurization mechanism 514 and the decompression mechanism 524. As a result, a pressure applied to ink flowing through the ink circulation path 41 fluctuates, which may lead to a failure in discharging from the discharge port 830 or unexpected drop of ink from the discharge port 830.

Therefore, in the present embodiment, the collecting-side individual pipe 63 connected to each of the heads 80 is provided with the protruding portion 631 protruding upward. The uppermost position of the protruding portion 631 is located higher than the uppermost position of the collecting-side manifold 64. Further, the collecting-side manifold 64 is located higher than each of the heads 80. Therefore, when air is mixed in ink stored in the ink chamber 832 or the internal tank 82, the air first moves to the vicinity of the uppermost position of the protruding portion 631 of the collecting-side individual pipe 63.

Further, an internal passage of the protruding portion 631 communicates with the space portion 525 formed above the liquid level of ink in the internal chamber 520 of the collecting tank 52 via the air pipe 65. Further, the uppermost position of the protruding portion 631 is located lower than the liquid level of ink stored in the collecting tank 52. Thus, the air moved to the vicinity of the uppermost position of the protruding portion 631 of the collecting-side individual pipe 63 is discharged to the space portion 525 of the collecting tank 52 via the air pipe 65. That is, air mixed in the ink circulation path 41 via the nozzles 83 and the like of the head 80 can be discharged to the space portion 525 of the collecting tank 52 via the air discharge path 45. Accordingly, it is possible to reduce generation of air accumulation in the ink circulation path 41 including the collecting-side individual pipe 63. As a result, a pressure applied to ink flowing through the ink circulation path 41 can be maintained at an appropriate value, and occurrence of a failure in discharging from the discharge port 830 and unexpected drop of ink from the discharge port 830 can be reduced.

Here, considering only discharging the air mixed in the ink circulation path 41 to outside, in addition to providing the structure like the air discharge path 45 of the present disclosure, for example, it is also conceivable to provide a so-called “air vent”, which is a general-purpose product, in each of the collecting-side individual pipes 63. However, if the so-called “air vent” is provided in each of the collecting-side individual pipes 63, the ink may also leak in addition to air when the air is evacuated. Therefore, it is necessary to separately provide a mechanism for inhibiting leakage of ink, which may increase cost.

Whereas, in the structure of the present embodiment, air mixed in ink in the head 80 and the collecting-side individual pipe 63 moves to the space portion 525 of the collecting tank 52 located higher than the uppermost position of the protruding portion 631, via the air pipe 65 and the protruding portion 631 located in an upper portion of each of the collecting-side individual pipes 63. Therefore, when the air moves from the air pipe 65 to the space portion 525 of the collecting tank 52, a possibility of leakage of ink is reduced in the first place due to the relationship of the pressure. Furthermore, even if ink leaks when air moves from the air pipe 65 to the space portion 525 of the collecting tank 52, the ink only merges with ink stored in the collecting tank 52, and then flows through the ink circulation path 41 as it is. That is, by using the structure of the present disclosure, it is possible to inhibit flowing of ink to the outside of the ink circulation path 41, and remove air mixed in the ink circulation path 41 including the collecting-side individual pipe 63.

When the printing process is executed to discharge ink droplets from the individual discharge heads 35 onto the surface of the continuous paper 10, an amount of ink stored in the supply tank 51 or the collecting tank 52 and an amount of ink flowing through the ink circulation path 41 decrease. Here, when the second liquid-level sensor 521 detects that the liquid level of ink stored in the internal chamber 520 of the collecting tank 52 is the second reference value L2, the second liquid-level sensor 521 outputs the second signal to the control unit 9. Then, when the second signal is output from the second liquid-level sensor 521, the control unit 9 determines that the liquid level of ink stored in the internal chamber 520 of the collecting tank 52 has fallen below the second reference value L2. Then, the control unit 9 stops driving of the circulation pump 71, closes the feedback-side on-off valve 75, and drives the replenishment pump 72. Note that the control unit 9 may decrease a driving amount of the circulation pump 71 and drive the replenishment pump 72, without closing the feedback-side on-off valve 75.

Furthermore, when the first lower liquid-level sensor 512 detects that the liquid level of ink stored in the internal chamber 510 of the supply tank 51 is the first lower reference value L12, the first lower liquid-level sensor 512 outputs the first lower signal to the control unit 9.

Then, when the first lower signal is output from the first lower liquid-level sensor 512, the control unit 9 determines that the liquid level of ink stored in the internal chamber 510 of the supply tank 51 has fallen below the first lower reference value L12. Then, also in this case, the control unit 9 stops driving of the circulation pump 71, closes the feedback-side on-off valve 75, and drives the replenishment pump 72. Note that the control unit 9 may decrease a driving amount of the circulation pump 71 and drive the replenishment pump 72, without closing the feedback-side on-off valve 75.

Ink delivered from the replenishment tank 53 by the replenishment pump 72 reaches the branch position 665, flows through the internal passage of the feedback pipe 66, and flows toward the supply tank 51. As a result, the amount of ink stored in the supply tank 51 and the collecting tank 52 increases. Here, when the second liquid-level sensor 521 detects that the liquid level of ink stored in the internal chamber 520 of the collecting tank 52 is the second reference value L2, the second liquid-level sensor 521 outputs the second signal to the control unit 9. When the second signal is output from the second liquid-level sensor 521, the control unit 9 determines that the liquid level of ink stored in the internal chamber 520 of the collecting tank 52 has exceeded the second reference value L2. Then, the control unit 9 stops the driving of the replenishment pump 72, ends the replenishment of ink to the ink circulation path 41, opens the feedback-side on-off valve 75, and drives the circulation pump 71 again.

Furthermore, when the first upper liquid-level sensor 511 detects that the liquid level of ink stored in the internal chamber 510 of the supply tank 51 is the first upper reference value L11, the first upper liquid-level sensor 511 outputs the first upper signal to the control unit 9. When the first upper signal is output from the first upper liquid-level sensor 511, the control unit 9 determines that the liquid level of ink stored in the internal chamber 510 of the supply tank 51 has exceeded the first upper reference value L11. Then, also in this case, the control unit 9 stops the driving of the replenishment pump 72, ends the replenishment of ink to the ink circulation path 41, opens the feedback-side on-off valve 75, and drives the circulation pump 71 again.

Thus, the control unit 9 stops the driving of the circulation pump 71 (or reduces the driving amount of the circulation pump 71), and drives the replenishment pump 72 to replenish ink from the replenishment tank 53 to the ink circulation path 41. As a result, an amount of ink in the entire ink circulation path 41 including the supply tank 51 and the collecting tank 52 can be increased. Then, the control unit 9 individually adjusts an amount of ink supplied from the supply tank 51 to the five heads 80 and an amount of ink collected from the five heads 80 to the collecting tank 52, by controlling driving of the pressurization mechanism 514 and the decompression mechanism 524. With such a configuration, the control unit 9 can more easily adjust the liquid level of ink stored in the internal chamber 520 of the collecting tank 52 to be located higher than the uppermost position of the protruding portion 631 of each of the collecting-side individual pipes 63.

However, the method of replenishing ink to the ink circulation path 41 is not limited thereto. For example, the control unit 9 may stop the driving of the circulation pump 71 (or reduce the driving amount of the circulation pump 71), and an operator or the like may manually add ink to the internal chamber 510 of the supply tank 51 or the internal chamber 520 of the collecting tank 52 to replenish ink to the ink circulation path 41. That is, it suffices that the control unit 9 is configured to control at least the circulation pump 71 such that the liquid level of ink is located higher than the uppermost position of the protruding portion 631 of the collecting-side individual pipe 63, on the basis of the detection result, which is obtained by the second liquid-level sensor 521, of the liquid level of ink stored in the internal chamber 520 of the collecting tank 52.

### 2. Second Preferred Embodiment

Next, an inkjet printing apparatus 1 according to a second preferred embodiment of the present disclosure is described. Note that the inkjet printing apparatus 1 according to the present embodiment is different from the inkjet printing apparatus 1 according to the first preferred embodiment only in details of a structure of the ink supply unit 4. Hence, only differences are described below. In addition, a portion having a structure equivalent to that of the first preferred embodiment is denoted by the same reference numeral as that of the corresponding portion in the first preferred embodiment.

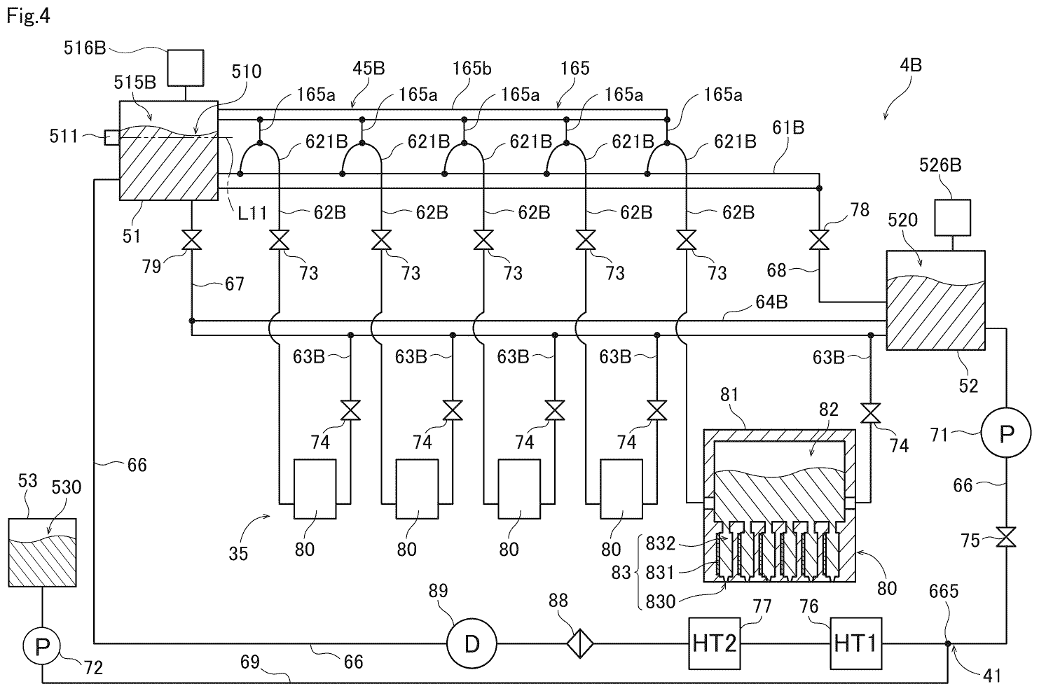

FIG. 4 is a view conceptually showing a configuration of one ink supply unit 4B and a configuration of one discharge head 35 according to the second preferred embodiment. As shown in FIG. 4, the ink supply unit 4B of the present embodiment includes a supply tank 51, a collecting tank 52, a replenishment tank 53, a supply-side manifold 61B, a plurality of supply-side individual pipes 62B, a plurality of collecting-side individual pipes 63B, a collecting-side manifold 64B, an air pipe 165, a feedback pipe 66, a first bypass pipe 67, a second bypass pipe 68, a branch pipe 69, a circulation pump 71, a replenishment pump 72, a plurality of supply-side on-off valves 73, a plurality of head outlet-side on-off valves 74, a feedback-side on-off valve 75, a first heater 76, a second heater 77, a first bypass on-off valve 78, a second bypass on-off valve 79, a filter 88, and a deaeration unit 89. In the present embodiment, each of the ink supply units 4B includes five supply-side individual pipes 62B, five collecting-side individual pipes 63B, five supply-side on-off valves 73, and five head outlet-side on-off valves 74.

The supply-side manifold 61B and the five supply-side individual pipes 62B are pipes connecting the supply tank 51 and five heads 80 included in one discharge head 35. The supply-side manifold 61B has an upstream end communicating with the supply tank 51 and is forked into the five supply-side individual pipes 62B. In addition, each of the five heads 80 of the present embodiment is located lower than the supply-side manifold 61B. Each of the five supply-side individual pipes 62B has an upstream end communicating with an internal passage of the supply-side manifold 61B, and has a downstream end that is connected so as to communicate with an internal tank 82 of one head 80. Further, the five supply-side individual pipes 62B are respectively connected to the upstream sides of the five heads 80 in an ink circulation path 41.

Further, in the present embodiment, a part of each of the supply-side individual pipes 62B has a curved shape protruding upward in an inverted U shape. Hereinafter, a portion protruding upward in each of the supply-side individual pipes 62B is referred to as a “protruding portion 621B”. The protruding portion 621B is located higher than a portion other than the protruding portion 621B in each of the supply-side individual pipes 62B. Further, an uppermost position of the protruding portion 621B is located higher than an uppermost position of the supply-side manifold 61B. However, the protruding portion 621B may protrude upward in an inverted V shape. Further, the protruding portion 621B may be formed at an end portion of each of the supply-side individual pipes 62B. That is, it suffices that each of the five supply-side individual pipes 62B has the protruding portion 621B protruding upward in an inverted U shape or an inverted V shape.

The five collecting-side individual pipes 63B and the collecting-side manifold 64B are pipes connecting the five heads 80 included in one discharge head 35 and the collecting tank 52. Each of the five collecting-side individual pipes 63B has an upstream end that is connected so as to communicate with the internal tank 82 of one head 80, and has a downstream end that is connected so as to communicate with an internal passage of the collecting-side manifold 64B. Further, the five collecting-side individual pipes 63B are respectively connected to the downstream sides of the five heads 80 in the ink circulation path 41. The collecting-side manifold 64B has a downstream end communicating with the collecting tank 52 and is forked into the five collecting-side individual pipes 63B. Note that, in FIG. 4, the collecting-side manifold 64B is shown to be located lower than the supply-side manifold 61B. However, the supply-side manifold 61B and the collecting-side manifold 64B are desirably located at substantially the same height as each other. This makes it possible to reduce a space occupied by the supply-side manifold 61B and the collecting-side manifold 64B in a vertical direction. Further, both the supply-side manifold 61B and the collecting-side manifold 64B desirably extend in a substantially horizontal direction. This makes it possible to stabilize delivery of ink in the supply-side manifold 61B and the collecting-side manifold 64B.

Further, the supply tank 51 is connected to a first decompression mechanism 516B. The first decompression mechanism 516B decompresses the inside of the supply tank 51 to regulate a pressure of an internal chamber 510 of the supply tank 51 to a slightly negative pressure. Further, the collecting tank 52 is connected to a second decompression mechanism 526B. The second decompression mechanism 526B decompresses the inside of the collecting tank 52 to regulate a pressure in an internal chamber 520 of the collecting tank 52 to a negative pressure. More specifically, the second decompression mechanism 526B regulates a pressure in the internal chamber 520 of the collecting tank 52 to be lower than an atmospheric pressure and to have a negative value larger in absolute value than a pressure in the internal chamber 510 of the supply tank 51.

Furthermore, a control unit 9 controls the circulation pump 71, the first decompression mechanism 516B, and the second decompression mechanism 526B such that a liquid level of ink is slightly higher than a first upper reference value L11, on the basis of a detection result of the liquid level of ink stored in the supply tank 51 obtained by a first upper liquid-level sensor 511 provided to the supply tank 51. Therefore, air is present above ink stored in the internal chamber 510 of the supply tank 51. That is, in the supply tank 51, a “space portion 515B” is formed above the stored ink. Further, the first upper reference value L11 is located higher than the uppermost position of the protruding portion 621B. That is, the uppermost position of the protruding portion 621B is located lower than the liquid level of ink stored in the supply tank 51.

The air pipe 165 includes a plurality of individual air pipes 165a and a common air pipe 165b. In the present embodiment, the air pipe 165 includes five individual air pipes 165a. Each of the five individual air pipes 165a is connected to one supply-side individual pipe 62B and extends upward. Further, each of the five individual air pipes 165a is connected to a portion of each corresponding supply-side individual pipe 62B near the uppermost position of the protruding portion 621B. The common air pipe 165b has a downstream end communicating with the supply tank 51 and is forked into the five individual air pipes 165a. Further, the common air pipe 165b is connected to an upper side surface of the supply tank 51. Thus, an internal passage of the air pipe 165 allows communication between an internal passage of each of the supply-side individual pipes 62B near the uppermost position of the protruding portion 621B and the space portion 515B formed in an upper portion of the internal chamber 510 of the supply tank 51, via the five individual air pipes 165a and the common air pipe 165b. Accordingly, the internal passage of each of the supply-side individual pipes 62B communicates with the space portion 515B of the supply tank 51 via the air pipe 165. As a result, an air discharge path 45B is formed from each of the supply-side individual pipes 62B toward the space portion 515B of the supply tank 51 via the air pipe 165. Note that, an inclination of the common air pipe 165b is not particularly limited as long as the entire common air pipe 165b is located higher than the first upper reference value L11. For example, the inclination of the common air pipe 165b may be horizontal. However, the common air pipe 165b desirably has an inclination in which an upstream end opposite to the downstream end connected to the supply tank 51 is located slightly higher than the downstream end. Thus, as will be described in detail later, even if ink leaks when air moves from the supply-side individual pipe 62B to the space portion 515B of the supply tank 51 via the air pipe 165, ink can be more easily directed into the supply tank 51 by the gravity applied to the ink.

When air is mixed in ink stored in an ink chamber 832 or the internal tank 82 of the head 80 at the time of discharging the ink, the air may move to the vicinity of the uppermost position of the protruding portion 621B of the supply-side individual pipe 62B. Then, the air is discharged to the space portion 515B of the supply tank 51 via the air pipe 165. That is, air mixed in the ink circulation path 41 via the nozzles 83 and the like of the head 80 can be discharged to the space portion 515B of the supply tank 51 via the air discharge path 45B. Accordingly, it is possible to reduce generation of air accumulation in the ink circulation path 41 including the supply-side individual pipe 62B. As a result, a pressure applied to ink flowing through the ink circulation path 41 can be maintained at an appropriate value, and occurrence of a failure in discharging from a discharge port 830 and unexpected drop of ink from the discharge port 830 can be reduced.

### 3. Modifications

Hereinabove, the preferred embodiments of the present disclosure have been described, but the present disclosure is not limited to the above-described preferred embodiments.

Furthermore, the individual elements appearing in the above-described first preferred embodiment and/or second preferred embodiment may be appropriately combined as long as no contradiction occurs.

While the invention has been shown and described in detail, the foregoing description is in all aspects illustrative and not restrictive. It is therefore understood that numerous modifications and variations can be devised without departing from the scope of the invention.

What is claimed is:

1. An inkjet printing apparatus that discharges ink onto a printing medium to perform printing, the inkjet printing apparatus comprising:
a plurality of heads configured to discharge ink;
a supply tank configured to store ink to be supplied to a plurality of the heads;
a collecting tank configured to store ink collected from a plurality of the heads;
a plurality of collecting-side individual pipes connected respectively to downstream sides of a plurality of the heads; and
a collecting-side manifold having a downstream end communicating with the collecting tank and forked into a plurality of the collecting-side individual pipes,
wherein each of a plurality of the heads is located lower than the collecting-side manifold,
a space portion is formed above stored ink in the collecting tank,
each of a plurality of the collecting-side individual pipes has a protruding portion protruding upward in an inverted U shape or an inverted V shape,
an uppermost position of the protruding portion is located higher than an uppermost position of the collecting-side manifold and lower than a liquid level of ink stored in the collecting tank, and
an air pipe allowing communication between an internal passage of the protruding portion and the space portion is further comprised.

2. The inkjet printing apparatus according to claim 1, further comprising a negative pressure application unit connected to the collecting tank and configured to apply a negative pressure to inside of the collecting tank.

3. The inkjet printing apparatus according to claim 1, further comprising:
a plurality of supply-side individual pipes connected respectively to upstream sides of a plurality of the heads;
a supply-side manifold having an upstream end communicating with the supply tank and forked into a plurality of the supply-side individual pipes; and
a feedback pipe configured to allow passage of ink fed back from the collecting tank to the supply tank.

4. The inkjet printing apparatus according to claim 3, further comprising a positive pressure application unit connected to the supply tank and configured to apply a positive pressure to inside of the supply tank.

5. The inkjet printing apparatus according to claim 3, further comprising:
a circulation pump configured to deliver ink from the collecting tank to the supply tank via the feedback pipe;
a control unit configured to control the heads and the circulation pump; and
a liquid-level sensor configured to detect a liquid level of ink stored in the collecting tank,
wherein the control unit controls the circulation pump such that a liquid level of ink is located higher than an uppermost position of the protruding portion, based on a detection result of a liquid level of ink, the detection result being obtained by the liquid-level sensor.

6. An inkjet printing apparatus that discharges ink onto a printing medium to perform printing, the inkjet printing apparatus comprising:
a plurality of heads configured to discharge ink;
a supply tank configured to store ink to be supplied to a plurality of the heads;
a plurality of supply-side individual pipes connected respectively to upstream sides of a plurality of the heads;
a supply-side manifold having an upstream end communicating with the supply tank and forked into a plurality of the supply-side individual pipes; and
a collecting tank configured to store ink collected from a plurality of the heads,
wherein each of a plurality of the heads is located lower than the supply-side manifold,
a space portion is formed above stored ink in the supply tank,
each of a plurality of the supply-side individual pipes has a protruding portion protruding upward in an inverted U shape or an inverted V shape,
an uppermost position of the protruding portion is located higher than an uppermost position of the supply-side manifold and lower than a liquid level of ink stored in the supply tank, and
an air pipe allowing communication between an internal passage of the protruding portion and the space portion is further comprised.
